(19) United States
(12) Patent Application Publication
(10) Pub. No.: US 2026/0179273 A1
(43) Pub. Date: Jun. 25, 2026

(54) COLOR RECOGNITION METHOD AND APPARATUS FOR CUPPING MARK IMAGE

(71) Applicants: CAPITALBIO CORPORATION, Beijing (CN); TSINGHUA UNIVERSITY, Beijing (CN)

(72) Inventors: Huihui TENG, Beijing (CN); Zhi ZHANG, Beijing (CN); Chensi CAO, Beijing (CN); Ruifang REN, Beijing (CN); Jing CHENG, Beijing (CN)

(73) Assignees: CAPITALBIO CORPORATION, Beijing (CN); TSINGHUA UNIVERSITY, Beijing (CN)

(21) Appl. No.: 19/129,131

(22) PCT Filed: Aug. 25, 2023
(86) PCT No.: PCT/CN2023/114913

§ 371 Date: May 12, 2025

(30) Foreign Application Priority Data
Nov. 17, 2022 (CN) 202211437597.7

(51) Int. Cl. G06T 11/10; G06T 7/70; G06T 7/90; H04N 1/56

(52) U.S. Cl. CPC G06T 11/10; G06T 7/70; G06T 7/90; H04N 1/56

(57) ABSTRACT

The present application provides a color recognition method and apparatus for a cupping mark image. The method comprises: obtaining a cupping mark image to be subjected to recognition; converting said cupping mark image into a preset target color space; compiling statistics on color distribution information of said cupping mark image in the target color space, wherein the color distribution information is used for indicating the number of pixels of different colors in said cupping mark image; and according to the color distribution information, determining a color determination result of said cupping mark image. In the present solution, global color distribution information of a cupping mark image to be subjected to recognition can be automatically collected and analyzed, and a color determination result of said cupping mark image is obtained according to the color distribution information, such that the automatic determination of the color of a cupping mark can be realized, and the accuracy of a determination result can also be improved.

This application the priority to Chinese Patent Application No. 202211437597.7, titled “COLOR RECOGNITION METHOD AND APPARATUS FOR CUPPING MARK IMAGE”, filed on Nov. 17, 2022 with the China National Intellectual Property Administration, which is incorporated herein by reference in its entirety.

### FIELD

The present disclosure relates to the technical field of image processing, and in particular to a method and an apparatus for recognizing a color of a cupping mark image.

### BACKGROUND

Cupping marks refer to marks in various morphologies and colors that appear on the skin surface at the suction sites after cupping and removing the cups. The cupping therapy is a traditional Chinese medicine treatment. Doctors generally observe the color and morphological features of cupping marks on different regions of the back after cupping to assess the functional state of internal organs and overall health. Therefore, accurate determination of the color of cupping marks is of great importance.

According to the conventional method for determining a color of a cupping mark, the cupping mark is captured to obtain a cupping mark image, pixel values of the cupping mark are extracted from multiple locations on the cupping mark image, and the color of the cupping mark is determined based on an average of the pixel values. However, this method has disadvantages that the pixel values of sparsely distributed locations on the cupping mark image fail to accurately reflect color information of the cupping mark image, resulting in low accuracy in color determination.

### SUMMARY

To address the disadvantages of the conventional technology mentioned above, a method and an apparatus for recognizing a color of a cupping mark image are provided according to the present disclosure, to accurately determine the color of the cupping mark image.

In a first aspect, a method for recognizing a color of a cupping mark image is provided according to the present disclosure. The method includes:
obtaining a to-be-recognized cupping mark image;
converting the to-be-recognized cupping mark image into a preset target color space;
statistically analyzing color distribution information of the to-be-recognized cupping mark image in the target color space, where the color distribution information indicates the number of pixels with different colors in the to-be-recognized cupping mark image; and
determining a color recognition result for the to-be-recognized cupping mark image based on the color distribution information.

In an embodiment, the obtaining a to-be-recognized cupping mark image includes:
obtaining an original cupping mark image captured using a camera device; and
performing image segmentation on the original cupping mark image to remove a skin region without a cupping mark in the original cupping mark image, to obtain the to-be-recognized cupping mark image.

In an embodiment, the statistically analyzing color distribution information of the to-be-recognized cupping mark image in the target color space includes:
determining a contour coordinate system with color components of the target color space as coordinate axes;
for each point of points in the contour coordinate system, counting the number of pixels in the to-be-recognized cupping mark image whose values on color components are consistent with coordinates of the each point, and determining a height of the point based on the counted result; and
connecting points with a same height in the contour coordinate system with a curve to obtain a contour map illustrating the color distribution information.

In an embodiment, before the determining a contour coordinate system with color components of the target color space as coordinate axes, the method further includes:
for each color component of the color components in the target color space, dividing a value range of the color component into multiple sub-intervals based on a preset step size of the color component, and determining an interval value of each sub-interval of the multiple sub-intervals; and
for each pixel of the pixels in the to-be-recognized cupping mark image, replacing values of the pixel on the color components with interval values of sub-intervals to which the values belong.

In an embodiment, the determining a color recognition result for the to-be-recognized cupping mark image based on the color distribution information includes:
calculating at least one height threshold based on heights of the points in the contour map;
for each height threshold of the at least one height threshold,
   selecting a contour line corresponding to the height threshold from the contour map as a target contour line; and
   determining the color recognition result for the to-be-recognized cupping mark image, based on preset color recognition intervals to which values on the color components of points on the target contour line belong, where each of the color recognition intervals corresponds to one color.

In a second aspect, an apparatus for recognizing a color of a cupping mark image is provided according to the present disclosure. The apparatus includes an obtaining unit, a converting unit, a statistical unit, and a determining unit.

The obtaining unit is configured to obtain a to-be-recognized cupping mark image.

The converting unit is configured to convert the to-be-recognized cupping mark image into a preset target color space.

The statistical unit is configured to statistically analyze color distribution information of the to-be-recognized cupping mark image in the target color space, where the color distribution information indicates the number of pixels with different colors in the to-be-recognized cupping mark image.

The determining unit is configured to determine a color recognition result for the to-be-recognized cupping mark image based on the color distribution information.

In an embodiment, for obtaining the to-be-recognized cupping mark image, the obtaining unit is further configured to:
obtain an original cupping mark image captured using a camera device; and
perform image segmentation on the original cupping mark image to remove a skin region without a cupping mark in the original cupping mark image, to obtain the to-be-recognized cupping mark image.

In an embodiment, for statistically analyzing the color distribution information of the to-be-recognized cupping mark image in the target color space, the statistical unit is further configured to:
determine a contour coordinate system with color components of the target color space as coordinate axes;
for each point of points in the contour coordinate system, count the number of pixels in the to-be-recognized cupping mark image whose values on color components are consistent with coordinates of the each point, and determine a height of the point based on the counted result; and
connect points with a same height in the contour coordinate system with a curve to obtain a contour map illustrating the color distribution information.

In an embodiment, the statistical unit is further configured to:
for each color component of the color components in the target color space, divide a value range of the color component into multiple sub-intervals based on a preset step size of the color component, and determine an interval value of each sub-interval of the multiple sub-intervals; and
for each pixel of the pixels in the to-be-recognized cupping mark image, replace values of the pixel on the color components with interval values of sub-intervals to which the values belong.

In an embodiment, for determining the color recognition result for the to-be-recognized cupping mark image based on the color distribution information, the determining unit is further configured to:
calculate at least one height threshold based on heights of the points in the contour map;
for each height threshold of the at least one height threshold,
   select a contour line corresponding to the height threshold from the contour map as a target contour line; and
   determine the color recognition result for the to-be-recognized cupping mark image, based on preset color recognition intervals to which values on the color components of points on the target contour line belong, where each of the color recognition intervals corresponds to one color.

A method and an apparatus for recognizing a color of a cupping mark image are provided according to the present disclosure. The method includes: obtaining a to-be-recognized cupping mark image; converting the to-be-recognized cupping mark image into a preset target color space; statistically analyzing color distribution information of the to-be-recognized cupping mark image in the target color space, where the color distribution information indicates the number of pixels with different colors in the to-be-recognized cupping mark image; and determining a color recognition result for the to-be-recognized cupping mark image based on the color distribution information. According to the solution, global color distribution information of the to-be-recognized cupping mark image is automatically collected and analyzed, and the color recognition result for the to-be-recognized cupping mark image is obtained based on the color distribution information, thus implementing the automatic recognition of the color of the cupping mark and improving the accuracy of the recognition result.

### BRIEF DESCRIPTION OF THE DRAWINGS

Hereinafter drawings to be applied in embodiments of the present disclosure or in the conventional technology are briefly described, in order to illustrate technical solutions according to embodiments of the present disclosure or in the conventional technology more clearly. Apparently, the drawings in the following descriptions are only some embodiments of the present disclosure, and other drawings may be obtained by those skilled in the art based on the provided drawings without any creative effort.

FIG. 1 is a flowchart of a method for recognizing a color of a cupping mark image according to an embodiment of the present disclosure;

FIG. 2 is a schematic diagram showing segmentation of an original cupping mark image according to an embodiment of the present disclosure;

FIG. 3 is a two-dimensional contour map showing the number of pixels with different combinations of hue and saturation components according to an embodiment of the present disclosure;

FIG. 4 is a two-dimensional contour map showing the number of pixels with different combinations of hue and value components according to an embodiment of the present disclosure;

FIG. 5 is a top view of a three-dimensional contour map obtained through statistics when a target color space is a HSV color space according to an embodiment of the present disclosure;

FIG. 6 is a perspective view of a three-dimensional contour map obtained through statistics when a target color space is a HSV color space according to an embodiment of the present disclosure;

FIG. 7 is a side view of a three-dimensional contour map obtained through statistics when a target color space is a HSV color space according to an embodiment of the present disclosure; and

FIG. 8 is a schematic structural diagram of an apparatus for recognizing a color of a cupping mark image according to an embodiment of the present disclosure.

### DETAILED DESCRIPTION

The technical solutions according to the embodiments of the present disclosure will be described clearly and completely as follows in conjunction with the drawings in the embodiments of the present disclosure. It is apparent that the described embodiments are only some of the embodiments according to the present disclosure, rather than all the embodiments. All other embodiments obtained by those skilled in the art based on the embodiments of the present disclosure without any creative work fall within the protection scope of the present disclosure.

To facilitate the understanding of the technical solutions in the present disclosure, some concepts that may be involved in the present disclosure are first explained.

The cupping diagnosis in traditional Chinese medicine (TCM), similar to the commonly known cupping (or fire cupping), is a TCM diagnostic and therapeutic method that uses specialized cupping devices to apply suction and other stimuli to specific reaction regions on the human back. In the cupping diagnosis, the color and morphological features of the cupping marks in different regions of the back are observed, so as to assess the functional state of internal organs and overall health. Currently, the application and research of cupping diagnosis mainly rely on visual observation and personal operational experience, and the color and morphological features of the cupping marks are determined according to relevant traditional Chinese medicine and western medicine theories. Although there is a certain consensus in TCM cupping diagnosis regarding the evaluation of the color and morphological features of cupping marks, the criteria for classifying and determining the color and morphological features of the cupping marks are still vaguely defined, and no precise and standardized classification methods and criteria are formed. As a result, different doctors may arrive at different diagnostic conclusions when evaluating the same cupping mark. The reliance on experience of doctors and the lack of objective criteria for determining the color and morphological features of the cupping marks limit the broader promotion and application of TCM cupping diagnosis. As described in the background, some conventional methods for automatically recognizing a color of a cupping mark by means of computer image processing capabilities often have disadvantages such as inaccurate determination results and the inability to reflect the overall color distribution of cupping mark images.

The HSV color space is a perception-based color model. HSV is an acronym of Hue, Saturation and Value. The hue component of the HSV color space has a significant skin clustering property, which is widely used in fields such as skin-related image segmentation, image retrieval, face detection, and the like. The HSV color space represents the color of a pixel as three components: hue, saturation, and value.

Hue is measured in degrees, ranging from 0 degrees to 360 degrees, starting from red and moving counterclockwise, where Red is at 0 degrees, yellow is at 60 degrees, green is at 120 degrees, cyan is at 180 degrees, blue is at 240 degrees, and magenta is at 300 degrees.

Saturation indicates the degree to which a color is close to a spectral color. A case that the color is closer to the spectral color indicates a higher saturation. Saturation ranges from 0% to 100%, with a higher saturation value indicating a more saturated color.

Value, also referred to as brightness, indicates the brightness of a color, ranging from 0% to 100%, corresponding to black to the spectral color (the brightest color of the current hue).

In an embodiment of the present disclosure, since the hue ranging from 0 degrees to 360 degrees starts and ends with red, to facilitate the continuity of quantifying the red hue, the hue interval corresponding to red in the HSV color space is shifted. The method of hue shifting may be either clockwise rotation or counterclockwise rotation, and the angle of rotation may be determined based on actual conditions, with the aim of adjusting the hue intervals corresponding to red on both sides of 0 degrees to a numerically continuous region. For example, the hue may be shifted clockwise by 20 degrees, so that the original interval representing red from 0 degrees to 20 degrees is adjusted to an interval from 340 degrees to 360 degrees, and correspondingly, the original interval representing red from 340 degrees to 360 degrees is adjusted to an interval from 320 degrees to 340 degrees. In this manner, for the adjusted HSV color space, a continuous numerical interval from 320 degrees to 360 degrees represents red.

The HSL color space is similar to the HSV color space, and also has three components: hue, saturation, and lightness. The lightness component L is different from the value component in the HSV color space, where for the value of the component L, 100 represents white, and 0 represents black.

The Lab color space is a color system based on physiological characteristics, mainly using digital methods to describe human visual perception. In the Lab color space, the color of a pixel may be represented by three components: L, a, and b. L represents lightness, with a value range of [0, 100]; a represents the component from green to red, with a value range of [127, −128]; and b represents the component from blue to yellow, with a value range of [127, −128].

The YUV color space is widely used in color television systems. The YUV color space separates brightness information from chrominance information, and the sampling rates of the brightness and chrominance for a same frame of image are set to be different. In the YUV color model, the color of a pixel may be represented by the brightness component Y and the chrominance components U and V, where the brightness component is independent of the chrominance components.

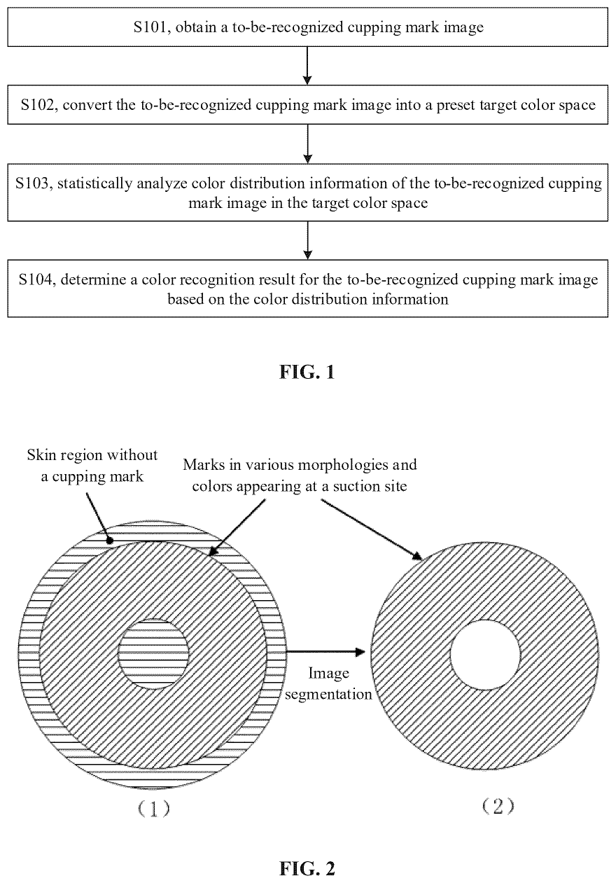

Referring to FIG. 1, FIG. 1 is a flowchart of a method for recognizing a color of a cupping mark image according to an embodiment of the present disclosure. The method includes the following steps S101 to S104.

In S101, a to-be-recognized cupping mark image is obtained.

In an embodiment, the process of obtaining a to-be-recognized cupping mark image includes:
obtaining an original cupping mark image captured using a camera device; and
performing image segmentation on the original cupping mark image to remove a skin region without a cupping mark in the original cupping mark image, to obtain the to-be-recognized cupping mark image.

Referring to FIG. 2, the original cupping mark image is obtained by using a camera device to photograph the area on the skin surface covered by the cupping device after cupping on the designated reaction area of the human back with specialized cupping devices and removing the cupping devices. Generally, due to the structure of the cup, there are skin regions without cupping marks (cupping marks are the marks of various morphologies and colors appearing after cupping) in the outer and central regions of the original cupping mark image, as shown in FIG. 2 (1). After the original cupping mark image is obtained, the skin regions without cupping marks in the original cupping mark image is removed through image segmentation, so as to obtain an image of the skin region completely covered by the cupping mark, as shown in FIG. 2 (2), that is, the to-be-recognized cupping mark image described in step S101.

In some embodiments, after the image of the region covered by the cupping mark is segmented from the original cupping mark image, image preprocessing may be further performed on the segmented image, and the preprocessed image may be determined as the to-be-recognized cupping mark image.

Image preprocessing may include adjusting the image size and performing image white balance.

Adjusting the image size can improve the execution efficiency of step S102 and subsequent steps. Performing image white balance can eliminate the interference of background light on the color of the pixel in the to-be-recognized cupping mark image, making a final color recognition result more accurate.

In S102, the to-be-recognized cupping mark image is converted into a preset target color space.

In an embodiment, the target color space may be any one of the aforementioned HSV color space, HSL color space, Lab color space, and YUV color space.

Specific description of conversion methods may be referred to technical literature related to these color spaces, which will not be repeated here.

In S103, color distribution information of the to-be-recognized cupping mark image in the target color space is statistically analyzed.

The color distribution information indicates the number of pixels with different colors in the to-be-recognized cupping mark image.

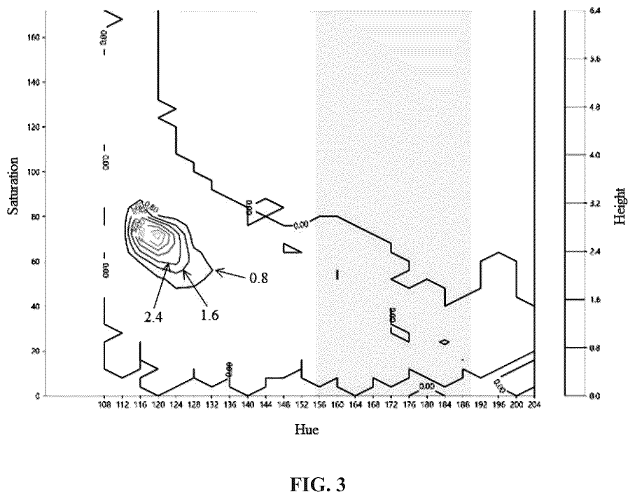

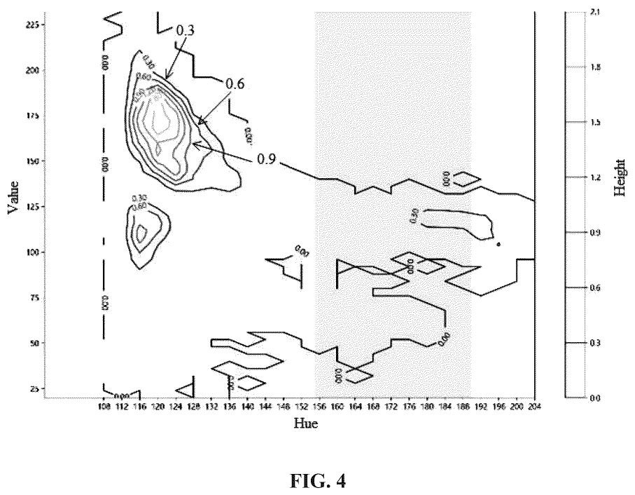

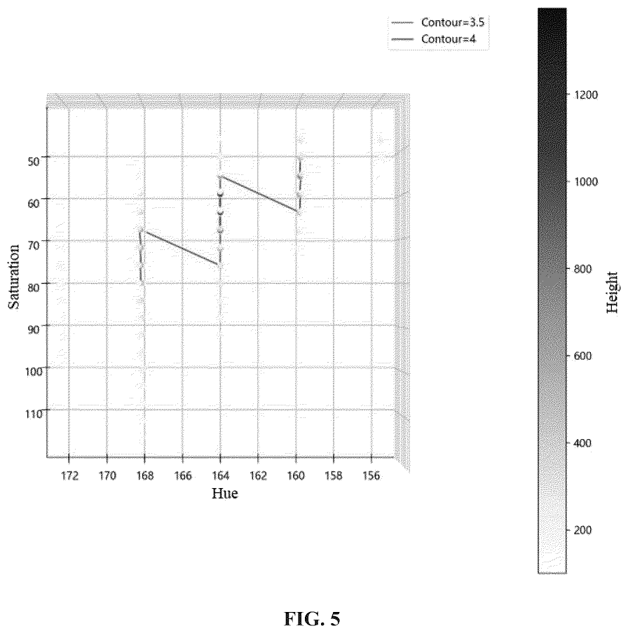

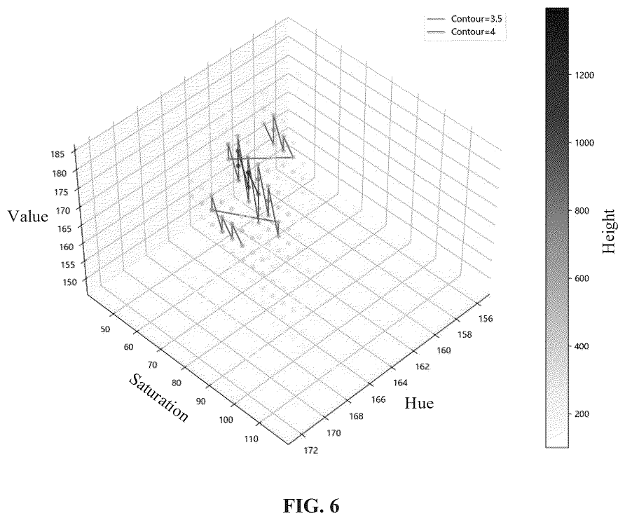

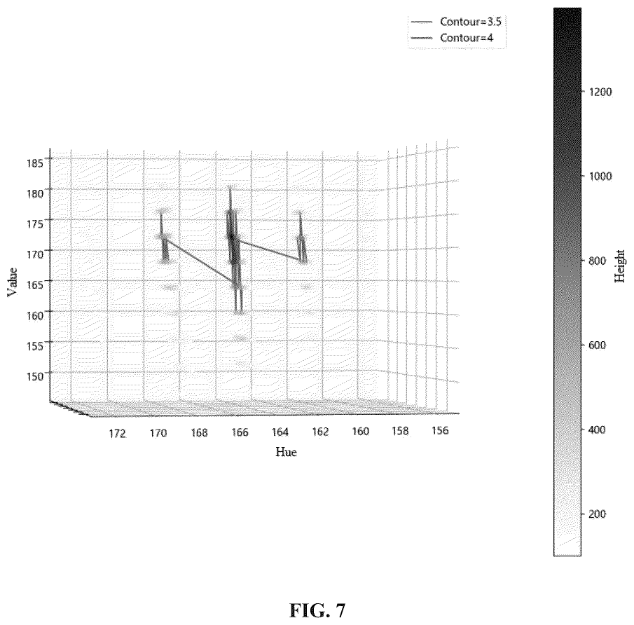

The color distribution information may be represented in different forms. In an embodiment, the color distribution information may be represented by the two-dimensional contour maps shown in FIG. 3 and FIG. 4, or by the three-dimensional contour maps shown in FIG. 5, FIG. 6, and FIG. 7.

FIG. 3 and FIG. 4 are two-dimensional contour maps illustrating the color distribution information of the to-be-recognized cupping mark image when the target color space is the HSV color space according to embodiments of the present disclosure.

FIG. 3 shows the number of pixels with different combinations of hue and saturation components. The horizontal axis of FIG. 3 represents the hue component of the pixels in the to-be-recognized cupping mark image, and the vertical axis represents the saturation component of the pixels in the to-be-recognized cupping mark image. The process of obtaining FIG. 3 is as follows. In the coordinate system of FIG. 3, a height is determined for each point in the coordinate system according to the following rules.

For each point, the number of pixels in the to-be-recognized cupping mark image whose values on hue and saturation components are consistent with the coordinates of the point is counted. A height of the point is determined based on the counted result. The height may be equal to the number of pixels in the to-be-recognized cupping mark image whose values on the hue and saturation components are consistent with the coordinates of the point, or may be equal to a proportion of the number of pixels in the to-be-recognized cupping mark image whose values on the hue and saturation components are consistent with the coordinates of the point to a total number of pixels in the to-be-recognized cupping mark image.

The following is an illustration with an example.

For a point (190, 60) in the coordinate system of FIG. 3, the horizontal coordinate of the point is 190 and the vertical coordinate of the point is 60. The number of pixels in the to-be-recognized cupping mark image whose value on the hue component is equal to 190 and value on the saturation component is equal to 60 is counted. If the counted result shows that 100 pixels have the hue component of 190 and the saturation component of 60, the height corresponding to the point (190, 60) may be set to 100. Alternatively, if the counted result shows that the pixels with the hue component of 190 and the saturation component of 60 account for 1% of pixels of the to-be-recognized cupping mark image, the height corresponding to the point (190, 60) may be set to 1%. The color scale on the right side of FIG. 3 represents the heights of points, where the heights are expressed in terms of proportion.

After the heights are determined according to the above rules, multiple points with a same height in FIG. 3 may be connected to form a contour line, so as to obtain multiple contour lines. Points on the same contour line have the same height, and different contour lines may correspond to different heights. For example, FIG. 3 shows three contour lines: 0.8 contour line, 1.6 contour line, and 2.4 contour line. Each point on the 0.8 contour line has a height of 0.8%, each point on the 1.6 contour line has a height of 1.6%, and each point on the 2.4 contour line has a height of 2.4%.

FIG. 4 shows the number of pixels with different combinations of hue and value components. The horizontal axis of FIG. 4 represents the hue component of the pixels in the to-be-recognized cupping mark image, and the vertical axis represents the value component of the pixels in the to-be-recognized cupping mark image. The process of obtaining FIG. 4 is as follows. In the coordinate system of FIG. 4, a height may be determined for each point in the coordinate system according to the following rules.

For each point, the number of pixels in the to-be-recognized cupping mark image whose values on hue and value components are consistent with the coordinates of the point is counted. A height of the point is determined based on the counted result. The height may be equal to the number of pixels in the to-be-recognized cupping mark image whose values on the hue and value components are consistent with the coordinates of the point, or may be equal to a proportion of the number of pixels in the to-be-recognized cupping mark image whose values on the hue and value components are consistent with the coordinates of the point to a total number of pixels in the to-be-recognized cupping mark image.

Similar to FIG. 3, after the heights are determined according to the above rules, multiple points with a same height in FIG. 4 may be connected to form a contour line, so as to obtain multiple contour lines. Points on the same contour line have the same height, and different contour lines may correspond to different heights.

According to the embodiments of the present disclosure, FIG. 5 to FIG. 7 are three-dimensional contour maps obtained through statistics and illustrate the color distribution information of the to-be-recognized cupping mark image when the target color space is the HSV color space. FIG. 5 is a top view of the three-dimensional contour map, FIG. 6 is a perspective view of the three-dimensional contour map, and FIG. 7 is a side view of the three-dimensional contour map.

Referring to FIG. 6, in the three-dimensional contour map, the coordinate of the X-axis represents the hue, the coordinate of the Y-axis represents the saturation, and the coordinate of the Z-axis represents the value.

The process of obtaining the three-dimensional contour maps shown in FIG. 5 to FIG. 7 is similar to the process of obtaining the two-dimensional contour maps described hereinbefore. A height is determined for each point in the three-dimensional coordinate system according to the following rules.

For each point, the number of pixels in the to-be-recognized cupping mark image whose values on hue, saturation and value components are consistent with the coordinates of the point is counted. For example, for a point with coordinates (100, 50, 60), the number of pixels in the to-be-recognized cupping mark image whose value on the hue component is equal to 100, value on the saturation component is equal to 50 and value on the value component is equal to 60 is counted. A height of the point is determined based on the counted result. The height may be equal to the number of pixels in the to-be-recognized cupping mark image whose values on the hue, saturation and value components are consistent with the coordinates of the point, or may be equal to a proportion of the number of pixels in the to-be-recognized cupping mark image whose values on hue, saturation and value components are consistent with the coordinates of the point to a total number of pixels in the to-be-recognized cupping mark image.

After the heights are determined according to the above rules, multiple points with a same height in the three-dimensional coordinate system may be connected to form a contour line, so as to obtain multiple contour lines in the three-dimensional coordinate system. Points on the same contour line have the same height, and different contour lines may correspond to different heights.

In an embodiment, in a case that the three-dimensional contour map is displayed on a visual interface of a terminal device, the height corresponding to each point may be represented by a color of the point. A darker color indicates a greater height, and a lighter color indicates a smaller height.

It can be understood that FIG. 3 to FIG. 7 are schematic diagrams of contour lines illustrating the color distribution information obtained through statistics under the premise that the target color space is determined to be the HSV color space.

The process of obtaining the two-dimensional and three-dimensional contour maps described above may further be applied to a case that the target color space is another color space (such as the Lab color space), and it is only required to correspondingly replace the color components of the HSV color space involved in the above process with the color components of another color space, which will not be repeated here.

Based on the process of determining the contour map described above, it may be determined that when the color distribution information is illustrated by the contour map, the specific execution process of step S103 may include:
determining a contour coordinate system with color components of the target color space as coordinate axes;
for each point in the contour coordinate system, counting the number of pixels in the to-be-recognized cupping mark image whose values on color components are consistent with the coordinates of the point, and determining a height of the point based on the counted result; and
connecting points with a same height in the contour coordinate system with a curve to obtain a contour map illustrating the color distribution information.

In some embodiments, when S103 is executed, the color components of all pixels in the to-be-recognized cupping mark image in the target color space may be statistically analyzed to obtain the color distribution information without processing.

In some embodiments, the color components of the to-be-recognized cupping mark image are compressed first, and then the color distribution information may be statistically analyzed based on the to-be-recognized cupping mark image after the compression. That is, the execution process of step S103 may include the following steps A1 to A2.

In A1, for each color component in the target color space, a value range of the color component is divided into multiple sub-intervals based on a step size of the color component, and an interval value of each sub-interval is determined.

The step sizes of different color components may be same or different. The HSV color space is taken as an example, when A1 is executed, the step size of the hue component may be 5, and the step size corresponding to the saturation component may be 10.

For example, for the HSV color space, it may be assumed that the step size of the hue component is 10, and the step sizes of the saturation and value components are 5. Consequently, the value range of hue from 0 degrees to 360 degrees may be divided into 36 sub-intervals, including from 0 degrees to 10 degrees, from 10 degrees to 20 degrees, . . . , from 350 degrees to 360 degrees. The value range of saturation from 0% to 100% may be divided into 20 sub-intervals including from 0% to 5%, from 5% to 10%, . . . , from 95% to 100%. Similarly, the value range of value may be divided into 20 sub-intervals including from 0% to 5%, from 5% to 10%, . . . , from 95% to 100%.

The interval value of each sub-interval is determined based on a value within the sub-interval. The specific method for determining the interval value is not limited in the embodiment. For example, the interval value of a sub-interval may be any one of the following: the average, maximum, minimum, median, quantile, mode, or midrange (that is, the average of the maximum and minimum within the interval) of the sub-interval.

The 36 sub-intervals of the hue are taken as an example, if the minimum value of each sub-interval is determined as the interval value of the sub-interval, the interval value of the sub-interval from 0 degrees to 10 degrees is 0 degrees, the interval value of the sub-interval from 10 degrees to 20 degrees is 20 degrees, and so on, and the interval value of the sub-interval from 350 degrees to 360 degrees is 350 degrees.

In A2, for each pixel in the to-be-recognized cupping mark image, values of the pixel on the color components are replaced with interval values of sub-intervals to which the values belong.

In step A2, the following operations may be performed on each pixel in the to-be-recognized cupping mark image.

It is determined which sub-interval of the color component the value on the color component of the pixel belongs to, where the sub-interval is one of the sub-intervals obtained by division in step A1. The value on the color component of the pixel is replaced with the interval value of the sub-interval to which the value belongs.

Continuing with the example of step A1, it is assumed that a pixel in the to-be-recognized cupping mark image has a hue of 136 degrees, a value of 72%, and a saturation of 34%. Based on the sub-intervals of hue, value, and saturation divided in step A1, it is determined that the hue of the pixel belongs to the sub-interval from 130 degrees to 140 degrees. Therefore, the value, 136 degrees, of the hue of the pixel is replaced with the interval value of the sub-interval from 130 degrees to 140 degrees, such as the minimum value of the sub-interval, which is 130 degrees.

Similarly, it is determined that the value of the pixel belongs to the sub-interval from 70% to 75%. The value of the value of the pixel, 72%, is replaced with the interval value of the sub-interval from 70% to 75%, such as the minimum value of the sub-interval, which is 70%.

The saturation of the pixel belongs to the sub-interval from 30% to 35%, and the saturation value of the pixel, 34%, is replaced with the interval value of the sub-interval from 30% to 35%, such as the minimum value of the sub-interval, which is 30%.

After the above operations are performed, the pixel has a hue of 130 degrees, a value of 70%, and a saturation of 30%.

It can be seen that through performing step A2, color components with similar values may be grouped into a same sub-interval, and the values may be uniformly set to the interval value of the sub-interval, thereby compressing data volume and improving efficiency.

It can be understood that when the solution for statistically analyzing the color distribution information after compressing color components is adapted, in the contour map illustrating the color distribution information, the coordinates corresponding to the color components are discontinuous. FIG. 3 is taken as an example, after the value ranges of the hue, value, and saturation components are divided into the sub-intervals according to the example in step A1, the coordinate values on the hue coordinate axis in FIG. 3 are discrete values: 0 degrees, 10 degrees, 20 degrees, . . . , up to 360 degrees. The interval between each two adjacent coordinate values is the step size for sub-interval division.

The advantage of statistically analyzing the color distribution information after compressing color components lies in that it can reduce the computational load when statistically analyzing the color distribution information and improve the execution efficiency of the embodiment.

In S104, a color recognition result for the to-be-recognized cupping mark image is determined based on the color distribution information.

In a case that the color distribution information is illustrated using the contour map (either the two-dimensional contour map or the three-dimensional contour map), the specific process of performing step S104 may include the following steps B1 to B3.

In B1, at least one height threshold is calculated based on heights of the points in the contour map.

In B2, for each height threshold, a contour line corresponding to the height threshold is selected from the contour map as a target contour line.

In B3, the color recognition result for the to-be-recognized cupping mark image is determined based on preset color recognition intervals to which values on the color components of the points in the target contour line belong, where each of the color recognition intervals corresponds to one color.

When step B1 is performed, if the color distribution information is illustrated by a three-dimensional contour map, any one or more of the following for the heights of all points in the three-dimensional contour map may be directly calculated: average, maximum, minimum, median, quantile, mode, and midrange. The calculated result serves as the at least one height threshold in B1. Alternatively, more height thresholds may be calculated using other algorithms. For example, 50% of the average of heights of all points is calculated and serve as a height threshold. The specific algorithm is not limited in the embodiment.

When the color distribution information is illustrated by a two-dimensional contour map, for one to-be-recognized cupping mark image, at least two two-dimensional contour maps are obtained through statistics. In this case, among the two two-dimensional contour maps, the two-dimensional contour map where the horizontal and vertical coordinates have a greater impact on the actual color presentation of the pixels is determined as a reference two-dimensional contour map. Any one or more of the following for the heights of all points in the reference two-dimensional contour map may be calculated: average, minimum, median, quantile, mode, midrange, 50% of the average and the like. The calculated result serves as the at least one height threshold in B1.

In step B2, if the color distribution information is illustrated by a three-dimensional contour map, the contour line corresponding to the height threshold may be determined as follows.

The contour line in the three-dimensional contour map whose height is equal to the height threshold is determined as the contour line corresponding to the height threshold. For example, if a contour line in the three-dimensional contour map has a height of 3.5, and a height threshold of 3.5 is calculated in B1, the contour line has a height of 3.5 is the target contour line corresponding to the height threshold of 3.5.

If the color distribution information is illustrated by a two-dimensional contour map, in the reference two-dimensional contour map determined in step B1, target contour lines respectively corresponding to all height thresholds are determined in the above manner.

It can be seen that through performing step B2, for each height threshold of the height thresholds, a unique target contour line corresponding to the height threshold is determined. The target contour line has a height equal to the height threshold.

In step B3, if the color distribution information is illustrated by a three-dimensional contour map, the color recognition result for the to-be-recognized cupping mark image may be determined as follows.

For points in each target contour line, it is sequentially determined which color recognition intervals the values on the color components of each point belong to. The colors corresponding to the color recognition intervals to which the points belong are determined as the color recognition result for the target contour line. The result includes at least one color. A set composed of non-repeating colors in the color recognition result of all target contour lines may be determined as the color recognition result for the to-be-recognized cupping mark image.

For example, if two target contour lines are determined from the three-dimensional contour map, where the color recognition result for one target contour line includes red and purple, and the color recognition result for the other target contour line is red, the combined set is red and purple. Thus, the color recognition result for the to-be-recognized cupping mark image is red and purple.

To implement the above method, at least one color recognition interval for each color component is preset, and each combination of color recognition intervals is set to correspond to one color. For example, in the HSV color space, the corresponding relation between the combination of color recognition intervals and the color may be shown in Table 1 below.

TABLE 1

| Color | Hue | Saturation | Value |
|---|---|---|---|
| Red | 156 to 190 | Greater than 60% | / |
| Pink | 156 to 190 | 35 to 60 | / |
| Purple | 125 to 155 | Greater than 60 | / |
| | | Greater than 52 | Less than 148 |
| Cyan | 125 to 155 | 25 to 50 | / |
| | 100 to 124 | Greater than 34 | / |
| White | 156 to 190 | 0 to 34 | Greater than 160 |
| | 125 to 155 | 0 to 24 | Greater than 160 |
| | 100 to 124 | 0 to 34 | Greater than 160 |
| Pink | Others | Others | Others |

The symbol “/” in a cell in Table 1 indicates that the cell is defaulted. The defaulted cell means that whether a color of a pixel is the color corresponding to the defaulted cell is independent of the color component corresponding to the defaulted cell. Red in Table 1 is taken as an example for illustration, and it can be seen that the defaulted cell in the “Value” column for the red row shows that whether the color of the pixel is red is independent of the value on the value component of the pixel.

The meanings of Table 1 are explained by taking the three colors, red, purple, and cyan as an example.

Red corresponds to the second row of Table 1. According to Table 1, it is determined that when the hue of a pixel is in the range of 156 to 190 and the saturation is above 60, the color of the pixel is red. The color recognition interval for red is: hue ranging from 156 to 190 and saturation greater than 60.

Based on the two rows corresponding to purple in Table 1, it is determined that when the hue of a pixel is in the range of 125 to 155 and the saturation is greater than 60, the color of the pixel is purple. Alternatively, when the hue of a pixel is in the range of 125 to 155, the saturation is greater than 52, and the value is less than 148%, the color of the pixel is purple. The color recognition interval for purple includes: hue ranging from 125 to 155 and saturation greater than 60; and hue ranging from 125 to 155, saturation greater than 52 and value less than 148.

Based on the two rows corresponding to cyan in Table 1, it is determined that when the hue of a pixel is in the range of 125 to 155 and the saturation is in the range of 25 to 50, the color of the pixel is cyan. Alternatively, when the hue of a pixel is in the range of 100 to 124 and the saturation is greater than 34, the color of the pixel is cyan. The color recognition interval for cyan includes: hue ranging from 125 to 155 and saturation ranging from 25 to 50; and hue ranging from 100 to 124 and saturation greater than 34.

Combining the example of Table 1, for any one target contour line of the target contour lines, if the color components of all points on the target contour line fall within the color recognition interval for purple in Table 1, the color recognition result for the target contour line is purple.

If the color components of a part of points on the target contour line fall within the color recognition interval for purple, and the color components of another part of points fall within the color recognition interval for cyan, the color recognition result for the target contour line is purple and cyan.

If the color components of a part of points on the target contour line fall within the color recognition interval for purple, and the color components of another part of points do not fall within any one of the color recognition intervals specified in Table 1, the color recognition result for the target contour line is purple and pink.

In a case that the color distribution information is illustrated by a two-dimensional contour map, the color recognition interval related two color components in the reference two-dimensional contour map may be predetermined. For example, the reference two-dimensional contour map is a two-dimensional contour map corresponding to hue and saturation, the color recognition interval related to hue and saturation for each common color may be predetermined.

For example, the color recognition interval for cyan includes: hue ranging from 125 to 155 and saturation ranging from 25 to 50; and hue ranging from 100 to 124 and saturation greater than 34.

For example, the color recognition interval for red is: hue ranging from 156 to 190 and saturation greater than 60.

Referring to the process of determining the color recognition result for the target contour line based on the three-dimensional contour map, the color recognition result for the target contour lines in the two-dimensional contour map is determined.

The color recognition interval for each color in the above determining process may be obtained based on color space settings and the empirical calculations by cupping diagnosis doctors.

The color recognition result for the to-be-recognized cupping mark image may include one or more colors. Specifically, when the color recognition result obtained by step B3 includes multiple colors, the multiple colors in the result may be deduplicated and merged according to preset deduplication rules and merging rules, so as to obtain a more accurate color recognition result. The deduplication rules and merging rules may be set based on the practical scenario and relevant experience in the field, which is not limited in the embodiments.

For example, the merging rules may include the following merging rules 1 to 3.

In merging rule 1, first priority levels for multiple common colors in cupping marks are defined. In a case that the color recognition result includes multiple colors, the multiple colors are sorted in descending order of the first priority levels, and only the top N colors are retained as the color recognition result for the to-be-recognized cupping mark image. N is a preset value, for example, it may be set to 2. An optional setting mode for the first priority level is that the first priority levels of red and purple are the same and the highest, and the first priority levels of white, cyan, and pink are the same and are lower than the first priority levels of red and purple.

The purpose of setting merging rule 1 is that a color with a higher first priority level often represents an abnormal cupping color. For example, red and purple are abnormal cupping colors. The presence of a small amount of red or purple in a cupping mark indicates an abnormality. Therefore, the color with the high first priority level is highlighted to serve as the color recognition result.

In merging rule 2, second priority levels for all the colors are determined based on the heights corresponding to the colors in the contour map. A higher height indicates a higher second priority level. The colors with the same first priority level are filtered in descending order of the second priority levels, and only the top N colors are retained as the color recognition result for the to-be-recognized cupping mark image. The height of a color in the contour map may be equal to a sum of the heights of points in the contour map whose coordinates fall within the color recognition interval of the color. It can be understood that a color with a higher height in the contour map indicates more pixels in the color in the to-be-recognized cupping mark image.

In Merging Rule 3, when the color recognition result includes multiple colors with different first priority levels, the multiple colors are sorted based on both the first priority levels and the second priority levels of the multiple colors. For example, the multiple colors are first sorted in descending order of the first priority levels, and then colors with the same first priority levels are sorted in descending order of the second priority levels. On completing sorting process, the top N colors are retained as the color recognition result for the to-be-recognized cupping mark image. For example, N may be set to 2. In a case that the color recognition result includes three colors, cyan, red and white, the three colors are sorted as red, cyan and white, and the top two colors, red and cyan, are retained as the color recognition result for the to-be-recognized cupping mark image.

In addition to the merging rules listed above, other merging rules may be set based on the organs targeted by the cupping diagnosis, which is not limited in the embodiments of the present disclosure. For example, for a lung cupping mark image obtained by cupping diagnosis on the lung, the color recognition result may simultaneously include red and purple, and may simultaneously include white and cyan.

In addition to the merging rules listed above, other merging rules may be set based on the diagnostic experience of doctors, which is not limited in the embodiments of the present disclosure.

The beneficial effects of the solution are as follows.

A method for analyzing a color of a cupping mark image is provided according to the present disclosure. Based on the method, recognition and classification of the overall/functional area color of the cupping mark are performed automatically, avoiding manual subjective influence, forming a unified standard for cupping color classification, and improving efficiency and reducing labor costs.

Moreover, according to the method, all color features of the cupping mark are extracted to form the color distribution information, and the range of color where colors trend or concentrate is obtained by using the contour line method and is determined as the cupping color recognition result. According to the method, all color information is fully considered, and important color information of the cupping mark is accurately obtained. In particular, the color recognition result for the cupping mark image with multiple color features is accurately determined.

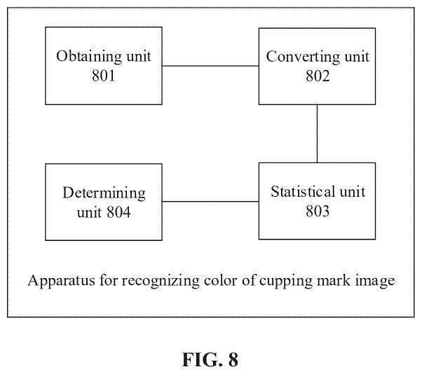

Based on the method for recognizing the color of the cupping mark image according to the embodiments of the present disclosure, an apparatus for recognizing a color of a cupping mark image is provided according to the embodiments of the present disclosure. As shown in FIG. 8, FIG. 8 is a schematic structural diagram of the apparatus. The apparatus includes an obtaining unit 801, a converting unit 802, a statistical unit 803, and a determining unit 804.

The obtaining unit 801 is configured to obtain a to-be-recognized cupping mark image.

The converting unit 802 is configured to convert the to-be-recognized cupping mark image into a preset target color space.

The statistical unit 803 is configured to statistically analyze color distribution information of the to-be-recognized cupping mark image in the target color space, where the color distribution information indicates the number of pixels with different colors in the to-be-recognized cupping mark image.

The determining unit 804 is configured to determine a color recognition result for the to-be-recognized cupping mark image based on the color distribution information.

In an embodiment, for obtaining the to-be-recognized cupping mark image, the obtaining unit 801 is further configured to:
obtain an original cupping mark image captured using a camera device; and
perform image segmentation on the original cupping mark image to remove a skin region without a cupping mark in the original cupping mark image, to obtain the to-be-recognized cupping mark image.

In an embodiment, for statistically analyzing the color distribution information of the to-be-recognized cupping mark image in the target color space, the statistical unit 803 is further configured to:
determine a contour coordinate system with color components of the target color space as coordinate axes;
for each point of points in the contour coordinate system, count the number of pixels in the to-be-recognized cupping mark image whose values on color components are consistent with coordinates of the each point, and determine a height of the point based on the counted result; and
connect points with a same height in the contour coordinate system with a curve to obtain a contour map illustrating the color distribution information.

In an embodiment, the statistical unit 803 is further configured to:
for each color component of the color components in the target color space, divide a value range of the color component into multiple sub-intervals based on a preset step size of the color component, and determine an interval value of each sub-interval of the multiple sub-intervals; and
for each pixel of the pixels in the to-be-recognized cupping mark image, replace values of the pixel on the color components with interval values of sub-intervals to which the values belong.

In an embodiment, for determining the color recognition result for the to-be-recognized cupping mark image based on the color distribution information, the determining unit 804 is further configured to:
calculate at least one height threshold based on heights of the points in the contour map;
for each height threshold of the at least one height threshold, select a contour line corresponding to the height threshold from the contour map as a target contour line; and
determine the color recognition result for the to-be-recognized cupping mark image, based on preset color recognition intervals to which values on the color components of points on the target contour line belong, where each of the color recognition intervals corresponds to one color.

The specific working principles and beneficial effects of the apparatus for recognizing the color of the cupping mark image according to the embodiments of the present disclosure may be referred to the relevant steps and beneficial effects in the method for recognizing the color of the cupping mark image according to the embodiments of the present disclosure, which will not be repeated here.

Finally, it should also be noted that in the present disclosure, relational terms such as first and second are only used to distinguish one entity or operation from another, and do not necessarily require or imply that any such actual relationship or order exists in these entities or operations. Furthermore, the term “comprise”, “include” or any other variation thereof is intended to cover a non-exclusive inclusion, so that a process, a method, an article, or a device including a set of elements includes not only those elements, but also other elements not expressly listed or elements inherent in such a process, method, article, or device. Unless expressively limited, the statement “including a . . . ” does not exclude the case that other similar elements may exist in the process, method, article or device including the series of elements.

It should be noted that, the terms “first”, “second” and so on mentioned in the present disclosure are only used to distinguish different apparatuses, modules or units, rather than limit an order or interdependence of functions performed by the apparatus, modules or units.

Those skilled in the art may implement or use the present disclosure. Various modifications made to these embodiments are apparent to those skilled in the art. The general principle defined herein may be implemented in other embodiments without departing from the spirit or scope of the present disclosure. Therefore, the present disclosure is not limited to the embodiments illustrated herein, but should be defined by the widest scope consistent with the principle and novel features disclosed herein.

1. A method for recognizing a color of a cupping mark image, comprising;
obtaining a to-be-recognized cupping mark image;
converting the to-be-recognized cupping mark image into a preset target color space;
statistically analyzing color distribution information of the to-be-recognized cupping mark image in the target color space, wherein the color distribution information indicates the number of pixels with different colors in the to-be-recognized cupping mark image; and
determining a color recognition result for the to-be-recognized cupping mark image based on the color distribution information.

2. The method according to claim 1, wherein the obtaining a to-be-recognized cupping mark image comprises:
obtaining an original cupping mark image captured using a camera device; and
performing image segmentation on the original cupping mark image to remove a skin region without a cupping mark in the original cupping mark image, to obtain the to-be-recognized cupping mark image.

3. The method according to claim 1, wherein the statistically analyzing color distribution information of the to-be-recognized cupping mark image in the target color space comprises:
determining a contour coordinate system with color components of the target color space as coordinate axes;
for each point of points in the contour coordinate system, counting the number of pixels in the to-be-recognized cupping mark image whose values on color components are consistent with coordinates of the each point, and determining a height of the point based on the counted result; and
connecting points with a same height in the contour coordinate system with a curve to obtain a contour map illustrating the color distribution information.

4. The method according to claim 3, wherein before the determining a contour coordinate system with color components of the target color space as coordinate axes, the method further comprises:
for each color component of the color components in the target color space, dividing a value range of the color component into a plurality of sub-intervals based on a preset step size of the color component, and determining an interval value of each sub-interval of the plurality of sub-intervals; and
for each pixel of the pixels in the to-be-recognized cupping mark image, replacing values of the pixel on the color components with interval values of sub-intervals to which the values belong.

5. The method according to claim 3, wherein the determining a color recognition result for the to-be-recognized cupping mark image based on the color distribution information comprises:
calculating at least one height threshold based on heights of the points in the contour map;
for each height threshold of the at least one height threshold,
selecting a contour line corresponding to the height threshold from the contour map as a target contour line; and
determining the color recognition result for the to-be-recognized cupping mark image, based on preset color recognition intervals to which values on the color components of points on the target contour line belong, wherein each of the color recognition intervals corresponds to one color.

6. An apparatus for recognizing a color of a cupping mark image, comprising:
an obtaining unit, configured to obtain a to-be-recognized cupping mark image;
a converting unit, configured to convert the to-be-recognized cupping mark image into a preset target color space;
a statistical unit, configured to statistically analyze color distribution information of the to-be-recognized cupping mark image in the target color space, wherein the color distribution information indicates the number of pixels with different colors in the to-be-recognized cupping mark image; and
a determining unit, configured to determine a color recognition result for the to-be-recognized cupping mark image based on the color distribution information.

7. The apparatus according to claim 6, wherein for obtaining the to-be-recognized cupping mark image, the obtaining unit is further configured to:
obtain an original cupping mark image captured using a camera device; and
perform image segmentation on the original cupping mark image to remove a skin region without a cupping mark in the original cupping mark image, to obtain the to-be-recognized cupping mark image.

8. The apparatus according to claim 6, wherein for statistically analyzing the color distribution information of the to-be-recognized cupping mark image in the target color space, the statistical unit is further configured to:
determine a contour coordinate system with color components of the target color space as coordinate axes;
for each point of points in the contour coordinate system, count the number of pixels in the to-be-recognized cupping mark image whose values on color components are consistent with coordinates of the each point, and determine a height of the point based on the counted result; and
connect points with a same height in the contour coordinate system with a curve to obtain a contour map illustrating the color distribution information.

9. The apparatus according to claim 8, wherein the statistical unit is further configured to:
for each color component of the color components in the target color space, divide a value range of the color component into a plurality of sub-intervals based on a preset step size of the color component, and determine an interval value of each sub-interval of the plurality of sub-intervals; and
for each pixel of the pixels in the to-be-recognized cupping mark image, replace values of the pixel on the color components with interval values of sub-intervals to which the values belong.

10. The apparatus according to claim 8, wherein for determining the color recognition result for the to-be-recognized cupping mark image based on the color distribution information, the determining unit is further configured to:
calculate at least one height threshold based on heights of the points in the contour map;
for each height threshold of the at least one height threshold,
select a contour line corresponding to the height threshold from the contour map as a target contour line; and
determine the color recognition result for the to-be-recognized cupping mark image, based on preset color recognition intervals to which values on the color components of points on the target contour line belong, wherein each of the color recognition intervals corresponds to one color.
